(19) United States
(12) Patent Application Publication
(10) Pub. No.: US 2016/0204479 A1
(43) Pub. Date: Jul. 14, 2016

(54) BATTERY PACK

(71) Applicant: Samsung SDI Co., Ltd., Yongin-si (KR)

(72) Inventor: Eunjoong Lee, Yongin-si (KR)

(21) Appl. No.: 14/925,453

(22) Filed: Oct. 28, 2015

(30) Foreign Application Priority Data
Jan. 9, 2015 (KR) 10-2015-0003462

(51) Int. Cl. H01M 10/42; H01M 2/20; H01M 2/02

(52) U.S. Cl. CPC H01M 10/4257; H01M 2/0217; H01M 2/204; H01M 2220/30; H01M 2010/4271

(57) ABSTRACT

A battery pack includes: a plurality of battery cells arranged side by side in a first direction; a frame accommodating the battery cells; and labels surrounding outer surfaces of the battery cells and the frame, wherein the frame includes concave portions formed between two neighboring battery cells of the battery cells and having a relatively thin thickness.

### RELATED APPLICATIONS

This application claims the benefit of Korean Patent Application No. 10-2015-0003462, filed on Jan. 9, 2015, in the Korean Intellectual Property Office, the disclosure of which is incorporated herein in its entirety by reference.

### BACKGROUND

1. Field

One or more exemplary embodiments relate to a battery pack.

2. Description of the Related Art

Unlike primary batteries, secondary batteries are rechargeable, and the use of second batteries is encouraged owing to economical and eco-friendly aspects thereof. Recently, various electronic devices use secondary batteries, and designs of such electronic devices become an important factor in making purchasing decisions.

The growth of markets for such portable electronic devices has increased demand for batteries suitable for operating such portable electronic devices. In addition, such portable electronic devices are increasingly required to be flexible in view of durability during transportation, storage, and impact, and thus the demand for flexible batteries has also increased.

### SUMMARY

One or more exemplary embodiments include a battery pack.

Additional aspects will be set forth in part in the description which follows and, in part, will be apparent from the description, or may be learned by practice of the presented embodiments.

According to one or more exemplary embodiments, a battery pack includes: a plurality of battery cells arranged side by side in a first direction; a frame accommodating the battery cells; and labels surrounding outer surfaces of the battery cells and the frame, wherein the frame includes first members of a first thickness and concave portions formed between first members of two neighboring battery cells of the battery cells having a thickness less than the first thickness.

The concave portions may include first and second concave portions respectively positioned at upper and lower portions of the battery cells in a length direction of the battery cells.

The frame further includes: a first frame having a rectangular shape; and a second frame disposed between two neighboring battery cells of the battery cells and connecting the first and second concave portions.

The first frame may be bendable in a second direction perpendicular to the first direction.

The labels may be formed of a flexible material.

The labels may be formed of a fabric.

The number of the labels may be smaller than the number of the battery cells by one, wherein each of the labels may have a width ranging from a widthwise center of a battery cell to a widthwise center of a neighboring battery cell, and the labels may surround the outer surfaces of the battery cells and the frame.

The labels may surround the battery cells and the frame in such a manner that the concave portions may aligned with centers of the labels.

The labels are sufficiently at center portions thereof at which the concave portions are positioned so as to permit bending of one battery cell with respect to another.

The battery pack may further include a protective circuit module disposed on an upper portion of one of the battery cells.

The battery pack may further include a cable through which the battery cells are electrically connected.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a schematic perspective view illustrating a battery pack according to an exemplary embodiment;

FIG. 2 is a schematic cross-sectional view of the battery pack;

FIG. 3 is a schematic view illustrating how the battery pack is bent or unbent according to the exemplary embodiment; and

FIG. 4 is a perspective view schematically illustrating a battery pack according to the exemplary embodiment.

### DETAILED DESCRIPTION

Reference will now be made in detail to exemplary embodiments, examples of which are illustrated in the accompanying drawings. In this regard, the present exemplary embodiments may have different forms and should not be construed as being limited to the descriptions set forth herein. Accordingly, the exemplary embodiments are merely described below, by referring to the figures, to explain aspects of the present description. As used herein, the term “and/or” includes any and all combinations of one or more of the associated listed items. In the descriptions of the exemplary embodiments, like reference numerals denote like elements.

It will be understood that although the terms “first” and “second” are used herein to describe various elements, these elements should not be limited by these terms. Terms are only used to distinguish one element from other elements.

In the following description, the technical terms are used only for explaining a specific exemplary embodiment while not limiting the inventive concept. The meaning of ‘include’ or ‘comprise’ specifies a property, a fixed number, a step, a process, an element, a component, and a combination thereof but does not exclude other properties, fixed numbers, steps, processes, elements, components, and combinations thereof

Hereinafter, exemplary embodiments will be described in detail with reference to the accompanying drawings.

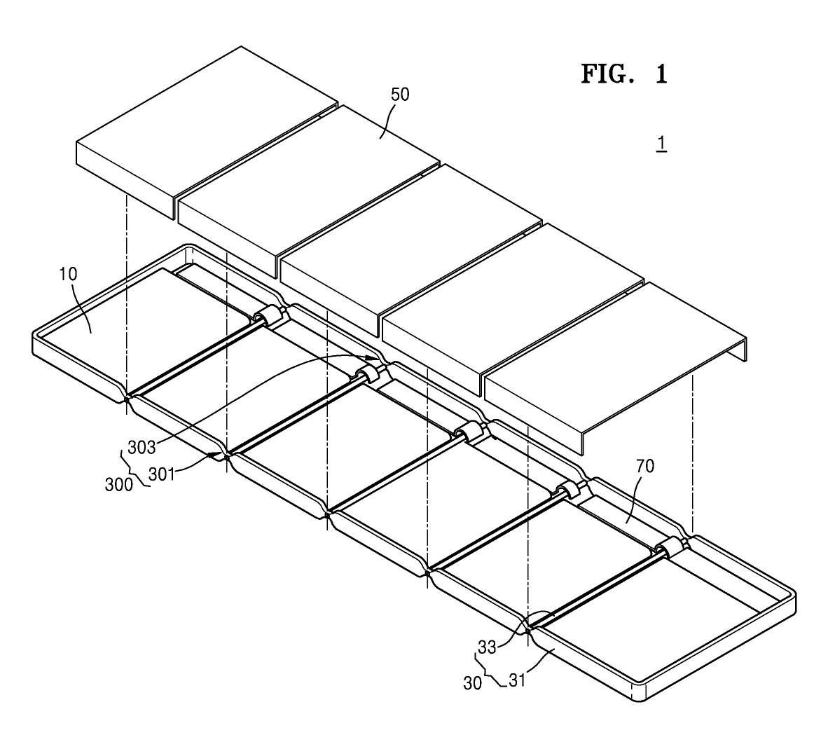

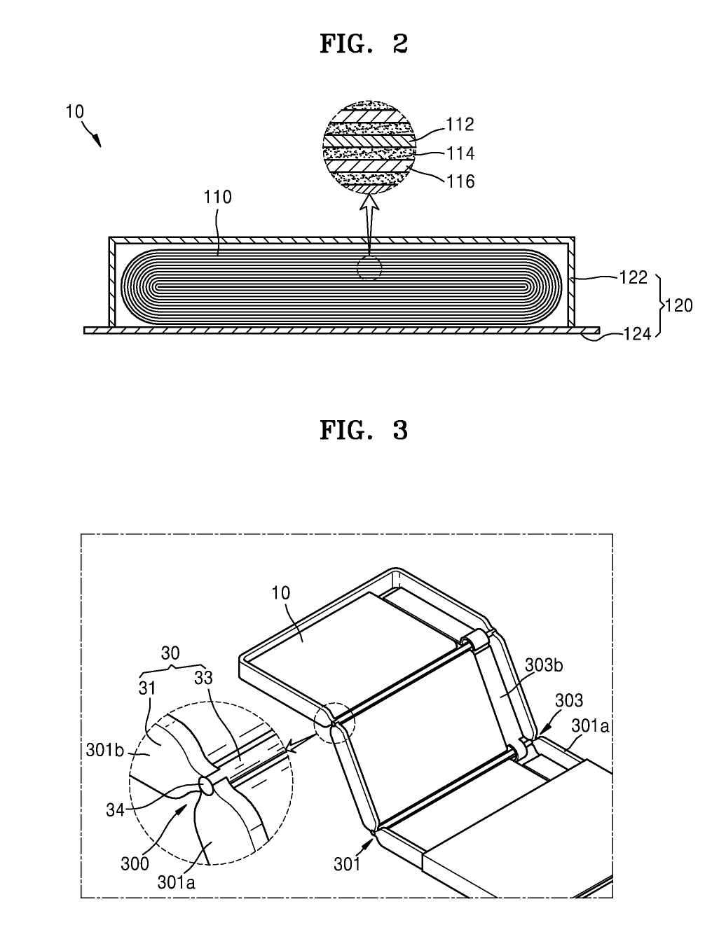

FIG. 1 is a schematic perspective view illustrating a battery pack 1 according to an exemplary embodiment. FIG. 2 is a schematic cross-sectional of the battery pack. Referring to FIGS. 1 and 2, the battery pack 1 of the exemplary embodiment may include a plurality of battery cells 10 and a frame 30 accommodating the battery cells 10.

The battery cells 10 may be arranged side by side in a first direction as shown in FIG. 1. In FIG. 1, six battery cells 10 are arranged side by side in the first direction. However, the arrangement direction and number of the battery cells 10 are not limited thereto.

As shown in FIG. 2, each of the battery cells 10 of the exemplary embodiment may include an electrode assembly 110 and a pouch 120 sealing the electrode assembly 110.

For example, the electrode assembly 110 may be manufactured by forming a stack including a positive electrode plate 112 coated with a positive electrode active material, a negative electrode plate 116 coated with a negative electrode active material, and a separator 114 disposed between the positive and negative electrode plates 112 and 116, and winding the stack in the form of a jelly roll. Alternatively, the electrode assembly 110 may be manufactured by sequentially stacking positive electrode plates 112, separators 114, and negative electrode plates 116.

The positive electrode plate 112 may include a positive electrode coating portion coated with a positive electrode active material, and a positive electrode non-coating portion not coated with the positive electrode active material. The positive electrode active material may be a lithium-containing transition metal oxide such as LiCoO₂, LiNiO₂, LiMnO₂, or LiMnO₄, or a lithium chalcogenide.

For example, the positive electrode coating portion may be formed by coating a portion of at least one side of an aluminum plate with the positive electrode active material, and the remaining portion of the aluminum plate not coated with the positive electrode active material may be the positive electrode non-coating portion.

The negative electrode plate 116 may include a negative electrode coating portion coated with a negative electrode active material, and a negative electrode non-coating portion not coated with the negative electrode active material. The negative electrode active material may be a carbon material such as crystalline carbon, amorphous carbon, a carbon composite, or carbon fiber, a lithium metal, or a lithium alloy.

For example, the negative electrode coating portion may be formed by coating a portion of at least one side of a copper plate with the negative electrode active material, and the remaining portion of the copper plate not coated with the negative electrode active material may be the negative electrode non-coating portion.

For example, the separator 114 may be formed by coating a base film with a co-polymer of polyvinylidene fluoride and hexafluoro propylene (PVDF-HFP co-polymer). The base film may be one selected from the group consisting of co-polymers of polyethylene (PE), polystyrene (PS), polypropylene (PP) and polyethylene (PE), and polypropylene (PP).

A first electrode tab (not shown) and a second electrode tab (not shown) may be attached to the electrode assembly 110. In detail, the first electrode tab 117 and the second electrode tab 119 may be respectively attached to the positive electrode non-coating portion and the negative electrode non-coating portion. The first electrode tab 117 and the second electrode tab 119 may extend outward through the pouch 120 sealing the electrode assembly 110.

For example, the pouch 120 may have a triple-layer structure formed by an insulation layer, a metal layer, and an insulation layer. For example, the metal layer may be formed of a material such as aluminum, steel, or stainless steel, and the insulation layers may be formed of a material such as chlorinated polypropylene (CPP), polyethylene terephthalate (PET), or nylon. However, the metal layer and the insulation layers are not limited thereto.

As shown in FIG. 1, the frame 30 may provide a space in which the battery cells 10 are accommodated and may be elongated in the first direction. As described above, the frame 30 may accommodate the battery cells 10.

In the exemplary embodiment, the battery pack 1 may further include labels 50 surrounding outer surfaces of the battery cells 10 and the frame 30.

After the battery cells 10 are accommodated in the frame 30, the labels 50 may be wound around the outer surfaces of the battery cells 10 and the frame 30 at one time. The labels 50 will be described later in more detail.

In the exemplary embodiment, the battery pack 1 may further include concave portions 300 on the frame 30 as shown in FIG. 1.

Each of the concave portions 300 is formed on the frame 30 at a position between two neighboring battery cells 10. The concave portions 300 may be thinner portions than other portions of the frame 30.

Since the relatively thin concave portions 300 are formed on the frame 30, the battery cells 10 may be rotated upward and downward on the concave portions 300 in different directions when compared to the frame 30 is straight without the concave portions 300. A detailed description of the movement of the battery pack 1 of the exemplary embodiment will be given later.

The concave portions 300 are thinner than other portions and may be formed on two sides of the frame 30. That is, when the battery cells 10 are accommodated in the frame 30, portions of the battery cells 10 from which the first and second electrode tabs 117 and 119 extend outward may be referred to as upper portions of the battery cells 10. Then, concave portions 300 formed on a side of the frame 30 facing the upper portions of the battery cells 10 may be referred to as first concave portions 301.

On the other hand, concave portions 300 formed on a side of the frame 30 facing lower portions of the battery cells 10 may be referred to as second concave portions 303. For clarity of illustration, the positions of the first and second concave portions 301 and 303 are mentioned as described above. However, the concave portions 301 and 303 are not limited thereto.

In the exemplary embodiment, the frame 30 of the battery pack 1 may include a first frame 31 having a rectangular shape and second frames 33 each positioned between two neighboring battery cells 10.

That is, as shown in FIG. 1, the first frame 31 may form a large rectangular border in which the battery cells 10 are accommodated. That is, the battery cells 10 may be accommodated in the first frame 31, and the second frames 33 may be disposed between the battery cells 10.

Each of the concave portions 300 may be formed between two neighboring battery cells 10, and the second frames 33 may connect the first and second concave portions 301 and 303.

The second frames 33 may have a length in the length direction of the battery cells 10. Since the second frames 33 are disposed between the battery cells 10, the number of the second frames 33 may be smaller than the number of the battery cells 10 by one.

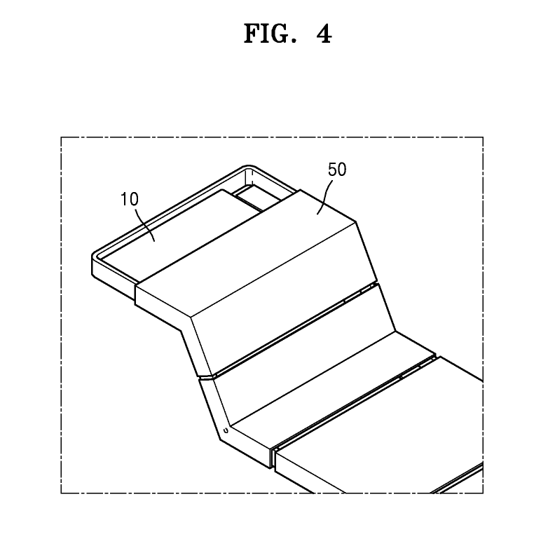

FIG. 3 is a schematic view illustrating how the battery pack 1 is bent or unbent according to the exemplary embodiment.

Since the concave portions 300 including the first and second concave portions 301 and 303 are formed between the battery cells 10, the battery pack 1 of the exemplary embodiment may be freely bent upward and downward at the concave portions 300.

That is, as shown in FIG. 3, the battery cells 10 and the frame 30 accommodating the battery cells 10 may be freely bent at the concave portions 300.

At this time, the battery cells 10 and the frame 30 may be bent in a second direction perpendicular to the first direction. That is, the battery cells 10 are arranged in the first direction, and the battery pack 1 may be freely bent in the second direction perpendicular to the first direction.

Therefore, according to the exemplary embodiment, the battery pack 1 may include a plurality of battery cells 10 and each of the battery cells 10 may be freely rotated in the second direction to impart flexibility to the battery pack 1.

More specifically, as shown in FIG. 3, in one embodiment, the second frames 33 may comprise a cylindrical member and the concave portions 301, 303 of the first frame 31 may define a round opening 34 that is sized so receive the ends of the second frame 33. For example, the concave portions 301, 303 may comprise two separate portions 301a, 301b and 303a 303b that are spaced apart from each other and each of the ends of the concave portions 301a,b, and 303a,b may have a half circular opening that receives a portion of the ends of the second frame 33 such that the second frame 33 holds the concave portions 301a,b and 303a,b together while allowing relative rotation of the ends of the concave portions 301a, 301b and 303a, 303b with respect to each other in the manner shown in FIGS. 3 and 4.

In another embodiment, the concave portions 301, 303 may be continuous between adjacent frame members 31 and formed of a resilient material and may be selected to be thinner than the rest of the first frame 31 such that the thinner concave can bend about an axis that is parallel to the second frames 33.

FIG. 4 is a schematic view illustrating the battery pack 1 according to the exemplary embodiment.

Referring to FIG. 4, the battery pack 1 of the exemplary embodiment may further include the labels 50 surrounding the outer surfaces of the battery cells 10 and the frame 30.

The labels 50 may be formed of a flexible material. Then, when the battery pack 1 is freely bent in the second direction, the labels 50 may be flexibly stretched without breakage, and thus the battery cells 10 disposed inside the labels 50 may be safely protected from external environments.

The labels 50 may be formed of any flexible material such as acetate.

Since the labels 50 are formed of a flexible material, noise may be reduced when the battery pack 1 is bent or moved, compared to the case in which the battery cells 10 are wrapped in relatively hard labels.

That is, if the labels 50 are formed of a flexible material such as acetate, the labels 50 may be soft and stretched according to the movement of the battery pack 1, and thus noise may be reduced.

In addition, since the labels 50 are stretchable according to the movement of the battery pack 1, no empty space may be formed between the battery pack 1 and the labels 50, and thus foreign substances may not be introduced into the battery pack 1. In other words, the bonding between the battery pack 1 and the labels 50 may be durably maintained.

The labels 50 may be formed of a fabric. For example, the labels 50 may be formed of a flexible acetate fabric. In this case, the labels 50 may be air-permeable owing to a mesh structure of the flexible acetate fabric, and thus circuits of the battery pack 1 may be easily cooled.

Furthermore, since the labels 50 are formed of a fabric having a mesh structure, bubbles may not be formed, and additional design specifications for preventing the generation of bubbles may not be necessary.

As shown in FIG. 4, each of the labels 50 may have a width ranging from the center of the width of a battery cell 10 to the center of the width of a neighboring battery cell 10. The labels 50 may have the same width and may wound around the outer surfaces of the battery cells 10 and the frame 30.

In addition, as shown in FIG. 4, the labels 50 may be wound around the outer surfaces of the battery cells 10 and the frame 30 in such a manner that the concave portions 300 may be positioned at the centers of the labels 50.

That is, in a state in which the concave portions 300 are positioned at the centers of the labels 50, widthwise ends of the labels 50 may be positioned at the widthwise centers of battery cells 10, and the other widthwise ends of the labels 50 may be positioned at the widthwise centers of neighboring battery cells.

As described above, since each of the labels 50 have a width ranging from the center of the width of a battery cell 10 to the center of the width of a neighboring battery cell 10, the labels 50 may be continuously attached to the above-mentioned positions. In this case, the number of the labels 50 may be smaller than the number of the battery cells 10 by one.

If the concave portions 300 are positioned at the centers of the labels 50, center portions of the labels 50 may receive most force when the battery pack 1 is freely bent at the concave portions 300.

Therefore, the labels 50 may be formed of a flexible material in such a manner that the center portions of the labels 50 may be the most flexible portions.

In this case, although the labels 50 receive force when the battery cells 10 and the frame 30 are bent at the concave portions 300, the labels 50 may be easily stretched and less damaged.

The battery pack 1 of the exemplary embodiment may further include a protective circuit module (not shown).

The protective circuit module may be disposed on the upper portion of one of the battery cells 10.

In addition, the battery pack 1 of the exemplary embodiment may further include a cable 70 to electrically electric connect the battery cells 10 as shown in FIG. 1.

The cable 70 may be disposed in the first frame 31 to electrically connect the battery cells 10.

As described above, according to the one or more of the above exemplary embodiments, the battery pack including a plurality of battery cells may be freely bent.

Other effects of the exemplary embodiments may be understood from the above description with reference to the accompanying drawings.

It should be understood that the exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. A battery pack comprising:
a plurality of battery cells arranged side by side in a first direction;
a frame accommodating the battery cells; and
labels surrounding outer surfaces of the battery cells and the frame,
wherein the frame comprises first members of a first thickness and concave portions formed between first members of two neighboring battery cells of the battery cells having a thickness less than the first thickness.

2. The battery pack of claim 1, wherein the concave portions comprise first and second concave portions respectively positioned at upper and lower portions of the battery cells in a length direction of the battery cells.

3. The battery pack of claim 2, wherein the frame further comprises:
a first frame having a rectangular shape; and
a second frame disposed between two neighboring battery cells of the battery cells and connecting the first and second concave portions.

4. The battery pack of claim 3, wherein the first frame is bendable in a second direction perpendicular to the first direction.

5. The battery pack of claim 1, wherein the labels are formed of a flexible material.

6. The battery pack of claim 5, wherein the labels are formed of a fabric.

7. The battery pack of claim 6, wherein the labels are formed of acetate.

8. The battery pack of claim 6, wherein the labels have a mesh structure.

9. The battery pack of claim 5, wherein the number of the labels is smaller than the number of the battery cells by one,
wherein each of the labels has a width ranging from a widthwise center of a battery cell to a widthwise center of a neighboring battery cell, and the labels surround the outer surfaces of the battery cells and the frame.

10. The battery pack of claim 9, wherein the labels surround the battery cells and the frame in such a manner that the concave portions are aligned with centers of the labels.

11. The battery pack of claim 9, wherein the labels are sufficiently flexibility at center portions thereof at which the concave portions are positioned so as to permit bending of one battery cell with respect to another.

12. The battery pack of claim 1, further comprising a protective circuit module disposed on an upper portion of one of the battery cells.

13. The battery pack of claim 1, further comprising a cable through which the battery cells are electrically connected.

14. A battery pack comprising:
a plurality of batteries arranged side by side in a first direction;
a frame comprising a plurality of sub-frames wherein the plurality of sub-frames receive one of the plurality of batteries;
labels that surround the plurality of batteries;
wherein at least some of the plurality of sub-frames that are adjacent to each other are bendable about an axis that extends in a second direction perpendicular to the first direction with respect to each other.

15. The battery pack of claim 14, wherein the sub-frames each comprise first members and second members and wherein the ends of the first members define a concave portion that is thinner than the first member.

16. The battery pack of claim 15, wherein the concave portion has a thinness selected to permit bending between adjacent sub-frames.

17. The battery pack of claim 15, wherein the second members are cylindrical members and the concave portions have an opening that receives the cylindrical member so as to permit bending of adjacent sub-frames.

18. The battery pack of claim 14, wherein the labels are formed of a flexible material.

19. The battery pack of claim 18 wherein the number of labels is smaller than the number of battery cells by one, and wherein each of the labels has a width ranging from the widthwise center of a first battery cell to the widthwise center of the adjacent battery cell and the label surrounds the outer surface of the battery cells and the frame.

20. The battery pack of claim 19, wherein the labels surround the battery cells and the frame in such a manner that the being axes are aligned with centers of the labels.
